(19) United States
(12) Patent Application Publication
(10) Pub. No.: US 2015/0158655 A1
(43) Pub. Date: Jun. 11, 2015

(54) Packaged Crabmeat Product

(71) Applicant: P.T. Toba Surimi Industries, Medan (ID)

(72) Inventor: Gindra Tardy, Medan (ID)

(73) Assignee: P.T. Toba Surimi Industries, Medan (ID)

(21) Appl. No.: 14/101,975

(22) Filed: Dec. 10, 2013

(51) Int. Cl. B65D 81/34; B65D 77/20; B65B 55/06; A23L 1/33; B65B 7/28; B65B 25/06

(52) U.S. Cl. CPC B65D 81/34; B65B 7/2864; B65B 25/061; B65B 55/06; A23L 1/33; B65D 77/2024; A23V 2002/00

(57) ABSTRACT

A packaged crabmeat product includes a metal body containing pasteurized crabmeat and having an opening to permit access to said crabmeat and a closure member releasably sealingly closing said opening, said closure member comprising at least a portion that is configured to permit viewing of said crabmeat through the closure member.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: None

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The invention relates to a packaged crabmeat product.

It is known to package crabmeat in:
1) metal cans that comprise a metal body and a lid made of the same metal and hermetically sealed to the body;
2) plastics tubs that have an aluminum easy open lid affixed to the tub; and
3) pouches that may be made of aluminum or a plastics material.

Each of these known packaged crabmeat products has problems or disadvantages such as the excessive migration of metal or plastics material into the crabmeat over time, insufficient body strength to protect the crabmeat against impact damage and not allowing the consumer to view the contents of the package without first opening it.

### BRIEF SUMMARY OF THE INVENTION

The invention provides a packaged crabmeat product comprising: a metal body containing pasteurized crabmeat and having an opening to permit access to said crabmeat; and a closure member releasably sealingly closing said opening, wherein said closure member comprises at least a portion that is configured to permit viewing of said crabmeat through the closure member.

The invention also provides a method of forming a packaged crabmeat product comprising: providing a metal body having an opening; disposing a portion of crabmeat in said metal body through said opening; releasably sealingly closing said opening with a closure member that comprises at least a portion configured to permit viewing of the crabmeat through said closure member; and pasteurizing said crabmeat in said metal body. It may also further comprise providing a peel layer on said closure member by which said closure member is releasably sealingly secured to said metal body.

The invention also provides a packaged crabmeat product comprising: a metal receptacle having walls defining a crabmeat receiving space and having an opening to access said crabmeat receiving space; a portion of pasteurized crabmeat in said receiving space; a plastics laminate closure member sealingly closing said opening; and at least one of a protective coating on said walls and a separate lining disposed between said walls and portion of crabmeat to at least partially protect said portion of crabmeat from contamination by said walls, wherein said closure member is secured to said metal receptacle so as to be removable from said metal receptacle by applying a pull force to a pull formation provided on said closure member.

### BRIEF DESCRIPTION OF THE SEVERAL VIEWS OF THE DRAWINGS

FIG. 1 is an exploded schematic side elevation view of a packaged crabmeat product;

FIG. 2 is a schematic sectional view of the packaged crabmeat product of FIG. 1;

FIG. 3 is an enlargement of a portion of FIG. 2 showing an annular member of the packaged crabmeat product;

FIG. 4 is a partial section view of a closure member of the packaged crabmeat product illustrating a laminate structure of the closure member; and

FIG. 5 is a flow diagram illustrating a method of forming a packaged crabmeat product.

### DETAILED DESCRIPTION OF THE INVENTION

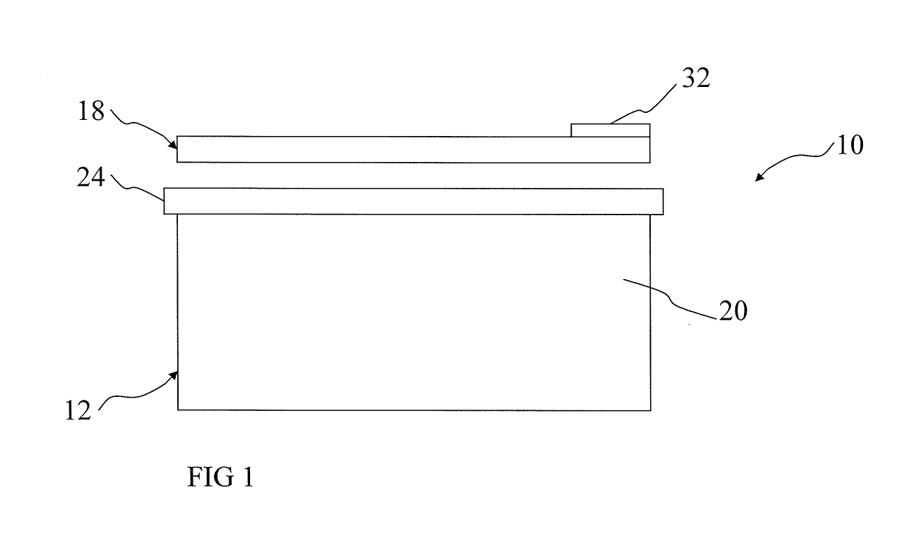

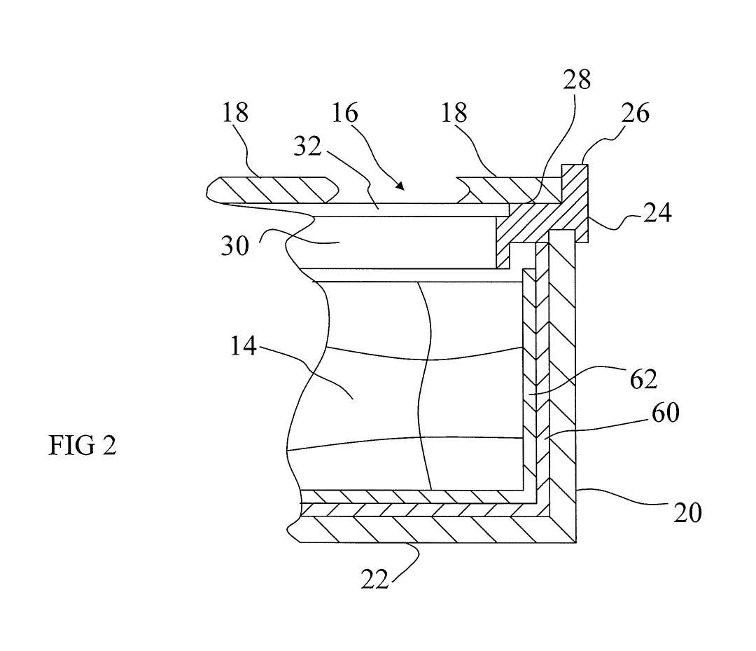

Referring to FIGS. 1 to 4, a packaged crabmeat product 10 comprises a metal body 12 containing pasteurized crabmeat 14 and having an opening 16 to permit access to the crabmeat. The packaged crabmeat product 10 further comprises a closure member 18 releasably sealingly closing the opening 16. The closure member 18 comprises at least a portion that is configured to permit viewing of the crabmeat 14 through the closure member.

The opening 16 is defined in the region of the free end of the side wall 20 by an annular member 24 that is secured to the side wall. The annular member 24 may be secured to the metal body 12 by a crimping or rolling process, or by means of a suitable soldering or adhering process. The annular member 24 may be a metal member and is preferably made of a metal having the same, or a similar, coefficient of thermal expansion as the metal from which the metal body 12 is made.

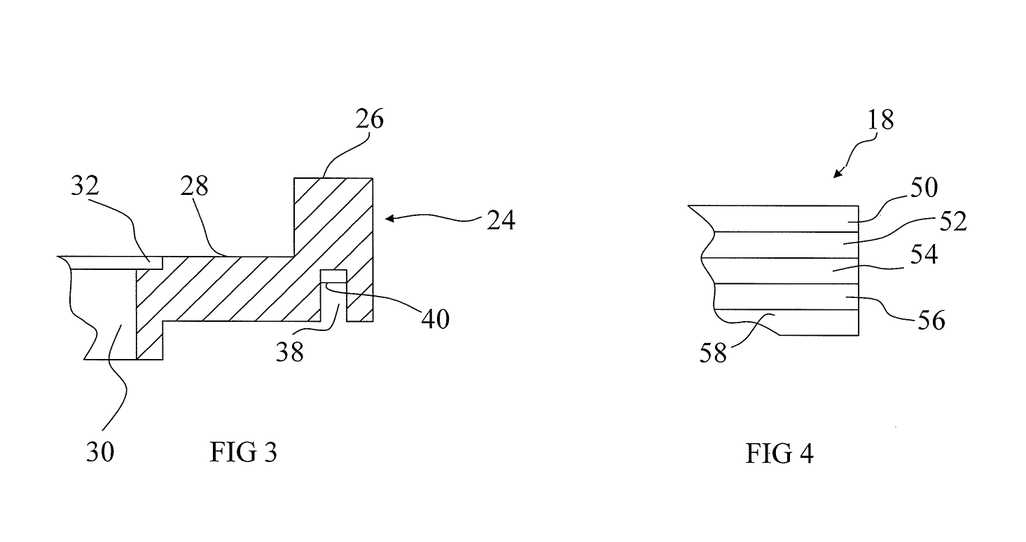

The annular member 24 comprises an upstanding outer side wall 26, an annular ledge 28 extending radially inwardly of the side wall 26 and a downwardly extending annular lip 30 at the radially inner edge of the ledge. The lip 30 defines the opening 16. The ledge 28 is disposed below the free, or upper, end of the outer side wall 26 so that the annular member 24 defines a recess to receive the closure member 18. An annular recess 32 may be provided in the upper face of the ledge 28 where it meets the lip 30 so as to ensure that there are no upward bulges, or discontinuities, at the inner periphery of the ledge that might interfere with sealing between the ledge and the closure member 18. An annular groove 38 (FIG. 3) is provided in the underside of the annular member 24 to receive the free end of the side wall 20 so that the annular member can seat on the side wall. In examples in which the annular member 24 is secured to the metal body 12 by crimping or rolling, a sealing material 40 may be provided in the groove 38. The sealing material 40 may be a deformable material and in the illustrated example comprises a resilient layer, for example made of rubber, pre-bonded to the annular member 24.

The closure member 18 is a plastics member with a circular profile configured to allow the closure member to seat on the ledge 28 with its outer periphery disposed radially inwardly of and adjacent the outer side wall 26 of the annular member 24. The upper side of the closure member 18 may be provided with a pull tab 32 (FIG. 4) or other means by which a consumer can apply a force to the closure member to pull the closure member away from the ledge 28. The configuration of the closure member 18 and of the recess defined by the outer side wall 26 and ledge 28 of the annular member 24 is preferably such that when the closure member is seated on the ledge, its upper surface is below the free end of the outer side wall 26 so that the closure member is completely received in the recess to provide protection for the closure member during transportation, handling and storage.

Although not essential, in the illustrated example, the closure member 18 is a plastics laminate. As best seen in FIG. 4, the laminate structure may comprise:

a layer 50 of polyethylene terephthalate (PET)

a printed layer 52

a layer 54 of PET SiOx

a layer 56 of PET

a polymer peel layer 58.

The layer thicknesses may be:

layer 50—23 microns

layer 54—12 microns

layer 56—12 microns

layer 58—50 microns

This overall thickness of the closure member 18 may be 0.109 mm plus or minus 10%.

In this example, the closure member 18 is substantially transparent across its entire major surface area, thereby making it easy to view the crabmeat 14. The only obstruction to sight of the crabmeat will be the printing of the printed layer 52. In general, it is likely to be preferable to minimize the amount of printing on the closure member 18 as this is likely to reduce the viewing area unnecessarily. In some examples, the printed layer 52 may comprise a solid band of color printed around the periphery of the closure member 18, thereby defining a centrally located viewing portion, or window.

In the example illustrated by FIG. 4, the closure member 18 releasably sealingly closes the opening 16 by adhesion between the peel layer 58 and the ledge 28. The material forming the peel layer 58 is one suitable for use in packaging foodstuffs and is selected to provide sufficient adhesion to maintain a seal during transport, handling and storage, yet allow removal by pulling on the tab 32 to peel the closure member 18 away from the ledge 28 so as to provide access to the crabmeat 14. The peel layer 58 may be a polyethylene or polypropylene peel layer. The peel layer 58 may extend across the entire major surface of the underside of the closure member 18 or be applied as an annular layer to an area of the closure member that will seat on the ledge 28.

In other examples, the peel layer 58 may be omitted and a suitable adhesive or bonding material provided on at least one of the outer periphery of the underside of the closure member 18 and the ledge 28. The adhesive or bonding material would be one suitable for use in packaging foodstuffs and selected to provide sufficient adhesion to maintain a seal during transport, handling and storage, yet allow removal by pulling on the tab 32 to peel the closure member 18 away from the ledge 28 so as to provide access to the crabmeat 14.

In the illustrated example, the closure member 18 is a laminate comprising five layers. It is to be understood that this is not essential as one or more layers may be omitted or added. For example, one or both of a transparent ultra violet (UV) blocking and a vapor blocking layer may be included in the laminate structure. Normal plastics materials will leak vapors over time so it may be desirable to include one or more vapor blocking layers to reduce such leakage and potentially extend the shelf life of the packaged crabmeat product. The vapor blocking layer may comprise a transparent aluminum oxide. The silicon oxide component of the PET SiOx layer 54 of the example illustrated in FIG. 4 may function as a vapor barrier. A laminate closure member such as that shown in FIG. 4 with an added UV and vapor blocking layer may have a thickness in the range 0.109 to 0.218 mm plus or minus 10%. It is presently anticipated that laminate structures with a thickness up to about 0.3 mm may be utilized and so in some examples, the closure member may have a thickness in the range of about 0.1 to 0.3 mm plus or minus 10%.

The inner walls of the metal body 12 may be coated with a suitable protective coating 60. The protective coating 60 may assist in isolating the crabmeat 14 from the metal body 12. The protective coating 60 may also provide a layer of protection in the event the plating is damaged or defective so that the crabmeat 14 will not be affected by any corrosion of the metal body 12 that might otherwise occur. The coating 60 may be a lacquer suitable for use in packaging foodstuffs, for example, polyethylene terephthalate.

A lining 62 may be provided between the metal body 12 and crabmeat 14. The lining 62 may cover the inner sides of the cylindrical side wall 20 and the bottom wall 22 and be provided as a one piece lining. The lining 62 may help to prevent metal from the metal body 12 leaching, or migrating, into the crabmeat 14 and adversely affecting its flavor. In the illustrated example, the lining 62 comprises a layer of parchment.

A vegetable oil such as olive or sunflower oil may be added to the crabmeat. The vegetable oil may be added after the crabmeat has been placed in the metal body 12. The vegetable oil, especially olive oil, may improve the flavor of the crabmeat 14. The vegetable oil may also assist in providing a barrier to metal leaching, or migrating, from the metal body 12 into the crabmeat.

Although not essential, the crabmeat 14 typically comprises chunks and similarly large portions of meat, rather than flakes or shredded crabmeat. Although not limited to this use, the metal body 12 and closure member 18 are particularly suitable for packaging premium crabmeat products such as colossal or jumbo chunks. This is because the metal body 12 provides the chunks with protection against damage during handling and storage of the packaged crabmeat product, while the crabmeat 14 can readily be inspected through the closure member 18 to allow a consumer to confirm the presence of undamaged chunks of crabmeat, rather than cheaper, less desirable, flakes and shredded crabmeat. However, it is to be understood that the crabmeat 14 may include any grade of crabmeat, including flakes and shredded crabmeat.

The packaged crabmeat package 10 may be provided with a paper label (not shown) wrapped around the metal body 12 and carrying details of the supplier and product contained in the package. Alternatively, the packaged crabmeat product 10 may be provided with a shrink wrap film wrapper (not shown) that may wrap around the metal body 12 and at least partially cover the closure member 18. The shrink film wrapper may be a PET shrink film wrapper. The shrink film wrapper may be printed with details of the supplier and product contained in the package. The engagement of the shrink film wrapper with the metal body 12 and closure member 18 may provide securing of the closure member to the metal body. When a shrink film wrapper is used, it is preferable to avoid printing on parts that will rest against the closure member so as not to reduce the viewing area unnecessarily.

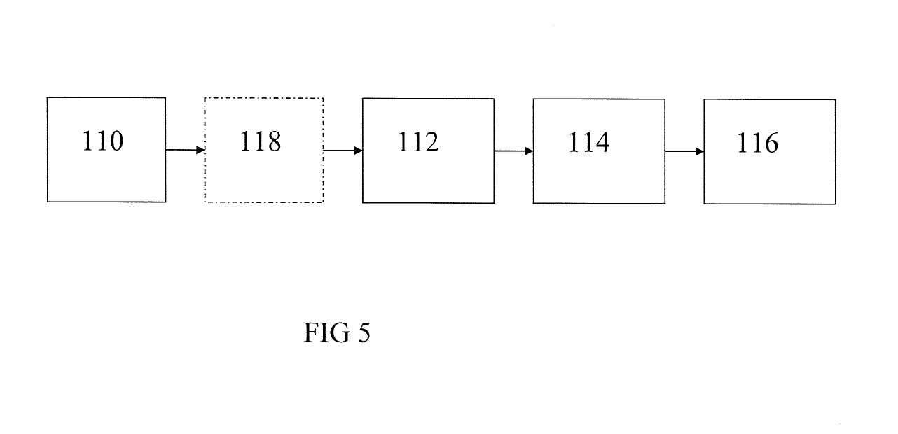

Referring to FIG. 5, in a method of forming a packaged crabmeat product 10, a metal body 12 having an opening 16 is provided at 110. A portion of crabmeat 14 is disposed in the metal body 12 through the opening 16 at 112. The opening 16 is releasably sealingly closed by a closure member 18 at 114. The closure member 18 comprises at least a portion configured to permit viewing of the crabmeat through the closure member. The crabmeat 14 is pasteurized at 116. The pasteurization may take place once the crabmeat has been disposed in the metal body 12 and the opening closed by the closure member 18 in which case, it may be necessary to provide a temporary securing mechanism to prevent breaking of the seal due to internal pressure build up in the can. Alternatively, the process may take place in a seafood packaging apparatus as disclosed by the Applicant's co-pending U.S. application Ser. No. 14/101,898 filed the same day as this application, the content of which is incorporated herein by reference. A lining 62 made, for example, of parchment may be provided in the metal body 12 prior to disposing the crabmeat 14 in the metal body at 112 as indicated by dashed lines at 118.

The packaged crabmeat product may provide good protection for the crabmeat, at least in part due to the inherent strength of the metal body, while providing visibility of the crabmeat for the consumer, thereby allowing the consumer to judge the quality of the crabmeat before purchasing the crabmeat. In examples in which the metal body is provided with a protective coating, such as the protective coating 60, a lining, such as the lining 62 is provided, or a vegetable oil is added to the crabmeat, the adverse effects of metal migration, or leaching, may be reduced or substantially avoided. This provides the possibility of a product having a longer shelf life with at least reduced a deterioration in the flavor or aroma of the crabmeat due to contamination from the metal body. Additionally, since the closure member 18 is not made of metal, there is no metal migration, or leaching, from the closure member into the crabmeat. Accordingly, it is possible to supply a product having high quality flavor or an attractive aroma with a longer shelf life.

In the specification above, reference may be made to features as ‘upper’ or ‘lower’. It is to be understood that this is not to be taken as limiting and the references are simply given for convenience in referencing the packaged crabmeat product in the orientation shown in the drawings.

It is to be understood that the illustrated and described examples are given to aid understanding of the invention and changes and modifications to the specifically-described examples may be carried out without departing from the principles of the present invention, which is intended to be limited only by the scope of the appended claims, as interpreted according to the principles of patent law, including the doctrine of equivalents.

Thus, although there have been described particular embodiments of the present invention of a new and useful Packaged crab meat product it is not intended that such references be construed as limitations upon the scope of this invention except as set forth in the following claims.

What is claimed is:

1. A packaged crabmeat product comprising:
a metal body containing pasteurized crabmeat and having an opening to permit access to said crabmeat; and
a closure member releasably sealingly closing said opening, wherein said closure member comprises at least a portion that is configured to permit viewing of said crabmeat through the closure member.

2. A packaged crabmeat product as claimed in claim 1, wherein said closure member is releasably sealingly secured to said metal body by adhesion.

3. A packaged crabmeat product as claimed in claim 2, wherein said adhesion is provided by a polymer peel layer disposed on said closure member.

4. A packaged crabmeat product as claimed in claim 1, wherein said closure member comprises a plastics member.

5. A packaged crabmeat product as claimed in claim 4, wherein said plastics member comprises a laminate.

6. A packaged crabmeat product as claimed in claim 1, wherein at least one inner side of said metal body is coated with a protective coating.

7. A packaged crabmeat product as claimed in claim 6, wherein said protective coating is a lacquer.

8. A packaged crabmeat product as claimed in claim 7, wherein said lacquer is polyethylene terephthalate.

9. A packaged crabmeat product as claimed in claim 1, further comprising a lining disposed between said metal body and said crabmeat.

10. A packaged crabmeat product as claimed in claim 1, wherein said crabmeat comprises crabmeat chunks.

11. A packaged crabmeat product as claimed in claim 1, further comprising a vegetable oil in said metal body with said crabmeat.

12. A packaged crabmeat product as claimed in claim 11, wherein said vegetable oil is olive oil.

13. A method of forming a packaged crabmeat product comprising:
providing a metal body having an opening;
disposing a portion of crabmeat in said metal body through said opening;
releasably sealingly closing said opening with a closure member that comprises at least a portion configured to permit viewing of the crabmeat through said closure member; and
pasteurizing said crabmeat in said metal body.

14. A method of forming a packaged crabmeat product as claimed in claim 13, further comprising providing a peel layer on said closure member by which said closure member is releasably sealingly secured to said metal body.

15. A method of forming a packaged crabmeat product as claimed in claim 13, further comprising providing a protective coating on at least one inner side surface of said metal body.

16. A method of forming a packaged crabmeat product as claimed in claim 15, wherein said protective coating is a lacquer.

17. A method of forming a packaged crabmeat product as claimed in claim 13, further comprising disposing a lining in said metal body and disposing said portion of crabmeat on said lining.

18. A packaged crabmeat product comprising:
a metal receptacle having walls defining a crabmeat receiving space and having an opening to access said crabmeat receiving space;
a portion of pasteurized crabmeat in said receiving space;
a plastics laminate closure member sealingly closing said opening; and
at least one of a protective coating on said walls and a separate lining disposed between said walls and portion of crabmeat to at least partially protect said portion of crabmeat from contamination by said walls,
wherein said closure member is secured to said metal receptacle so as to be removable from said metal receptacle by applying a pull force to a pull formation provided on said closure member.

19. A packaged crabmeat product as claimed in claim 18, wherein said metal receptacle comprises an upstanding side wall and an annular member secured to said side wall, said annular member defining a recess and said opening which opening is disposed in said recess.

20. A packaged crabmeat product as claimed in claim 18, wherein said closure member is secured to said metal receptacle by a peel polymer disposed on a surface of said closure member.
